(19) United States
(12) Patent Application Publication
(10) Pub. No.: US 2011/0036555 A1
(43) Pub. Date: Feb. 17, 2011

(54) METHOD AND APPARATUS FOR DISCHARGING A NON-LINEAR CRYOGEN SPRAY ACROSS THE WIDTH OF A MILL STAND

(75) Inventors: Guido Plicht, Dortmund (DE); Robert James Edwards, Macungie, PA (US); Michael Dennis Lanyi, Kempton, PA (US); Zbigniew Zurecki, Macungie, PA (US); Detlef Bennewitz, Herne (DE); Harald Schillak, Bochum (DE)

Correspondence Address: AIR PRODUCTS AND CHEMICALS, INC.;PATENT DEPARTMENT, 7201 HAMILTON BOULEVARD, ALLENTOWN, PA, 181951501, US

(73) Assignee: AIR PRODUCTS AND CHEMICALS, INC., Allentown, PA (US)

(21) Appl. No.: 12/675,274

(22) PCT Filed: Aug. 27, 2008
(86) PCT No.: PCT/US08/74482

§ 371 Date: Sep. 15, 2010

Related U.S. Application Data
(60) Provisional application No. 60/968,479, filed on Aug. 28, 2007.

(51) Int. Cl. B21B 27/06; G05D 23/00

(52) U.S. Cl. 165/287; 72/201

(57) ABSTRACT

A method and apparatus for determining a non-linear cryogenic cooling profile (16) for the purpose of improving rolled product (5) uniformity based on at least one operating parameter in a cold rolling process; and generating the non-linear cryogenic cooling profile (16) as a function of throttling gas pressure.

### CROSS-REFERENCE TO RELATED APPLICATION(S)

This application is the National Stage of International Application No. PCT/US08/74482, filed Aug. 27, 2008, which claims the benefit of U.S. Provisional Application No. 60/968,479, filed Aug. 28, 2007, which is incorporated herein by reference in its entirety as if fully set forth.

### BACKGROUND

The present invention is directed to the use of cryogenic spay devices in cold rolling processes, as well as other industrial applications, such as hot and profile rolling and thermal spray coating of cylindrical shapes.

Cold rolling is a process used to produce metallic sheet or strip with specific mechanical properties such as surface finish and dimensional tolerances. In a cold rolling operation, the metallic sheet or strip (rolled product) passes between two counter-rotating work rolls adjusted at a predetermined roll gap so that the rolled product is plastically deformed to a required thickness defined by the selected gap setting.

Cold rolling generates heat in response to the forces required to deform the strip and friction between the work rolls and the rolled product. This generated heat accumulates in both the work rolls and rolled product, and it must be dissipated to maintain mill stand temperature at acceptable cold rolling levels. Cold rolling temperatures are normally above about 120° C. in a cold reduction mill, and about 205° C. in a high-speed cold tandem mill. Excessive rolling temperatures adversely affect the rolled product properties, causing surface oxidation, defects in surface quality, and inconsistent gauge, shape, and flatness, hereinafter referred to as “product shape.”

Several techniques, including the use of cryogenic and non-cryogenic cooling devices, water, and lubricants, for example, have been used to keep strip and work roll temperatures within acceptable ranges. In addition, attempts have been made to keep mill temperatures within a desired range by varying the overall intensity of a uniform cryogenic spray profile based on data received from optical pyrometers directed at a roll surface.

In many cold rolling processes, flatness and uniformity in the gauge of the rolled product is desirable. Work rolls, which are supported at their ends in the mill stand roll bearings, tend to deflect under the high loads required for cold rolling. Accordingly, a work roll subjected to uniformly distributed loads across its width will deflect more at its center that at its ends which, in turn, produces a thicker center and thinner edges in the rolled product.

Various attempts have been made to address this problem. Several types of work-roll bending techniques have been used, through which one or both of the work rolls is bent toward the strip in an attempt to improve strip cross-sectional uniformity. Such techniques tend to increase stress and wear on work roll components and often do not fully correct the problem.

Another common problem relating to strip flatness is crowning of the strip or curling of the edges of the strip due to uneven heating and/or cooling of the strip during the cold rolling process. Most conventional cooling techniques (especially conventional cryogenic cooling techniques) provide uniform cooling profiles across the width of the strip, and therefore, do nothing to alleviate this problem.

Related art includes German Patent Number DE 199 53 230, PCT Publication No. WO 2006/074875 A1, and U.S. Pat. No. 4,481,800.

### SUMMARY OF THE INVENTION

In one respect, the invention comprises a method including the steps of determining a non-uniform cryogenic cooling profile for a discharge of a cryogenic cooling device that is part of an industrial process based on at least one operating parameter of the industrial process and generating the non-uniform cryogenic cooling profile.

In another respect, the invention comprises an apparatus for use in an industrial process. The apparatus includes a cryogenic spray device having at least one discharge opening, the cryogenic spray device being connected to at least one cryogenic fluid supply line and at least one discharge opening, the cryogenic spray device being configured so that flow of cryogenic fluid through each of the at least one discharge opening is a function of the pressure at which a throttling gas is supplied to each of the at least one throttling gas supply line. The apparatus further includes at least one valve that regulates flow of the throttling gas through each of the at least one throttling gas supply line and a controller having at least one sensor adapted to measure at least one operating parameter of the industrial process. The controller is programmed to adjust each of the at least one valve to generate a desired cryogenic cooling profile for the cryogenic spray device based on input from the at least one sensor.

### BRIEF DESCRIPTION OF THE DRAWINGS

FIG. 1 is a schematic isometric view showing one embodiment of a cryogenic cooling device in an exemplary mill stand;

FIG. 2A is a front view of the embodiment of a cryogenic cooling device shown in FIG. 1;

FIG. 3 is a diagram showing exemplary delivery and control systems associated with the embodiment of the cryogenic cooling device shown in FIGS. 1 and 2A;

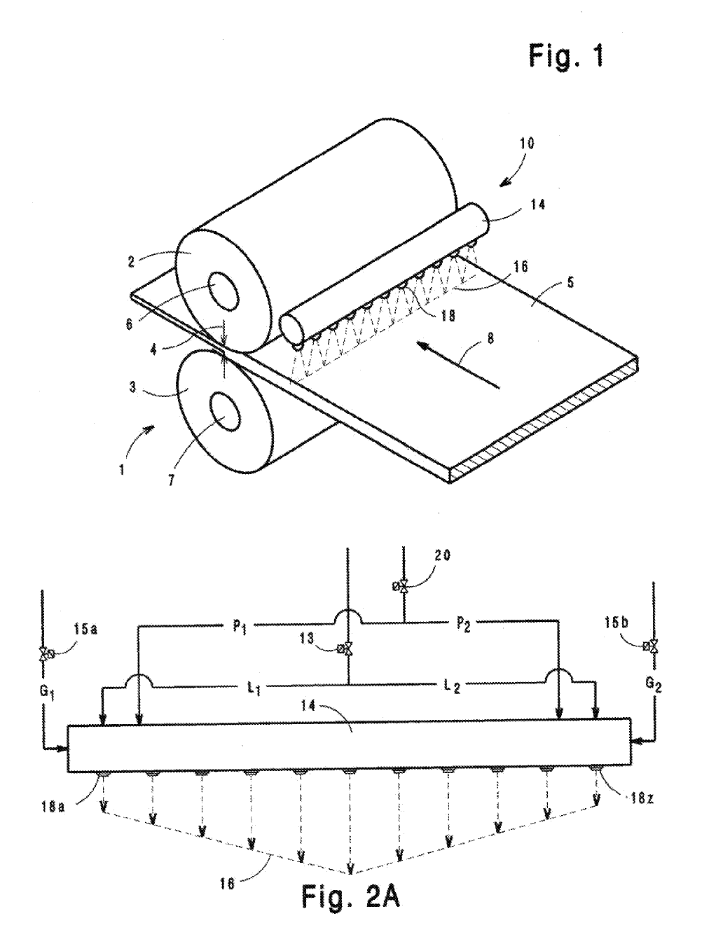

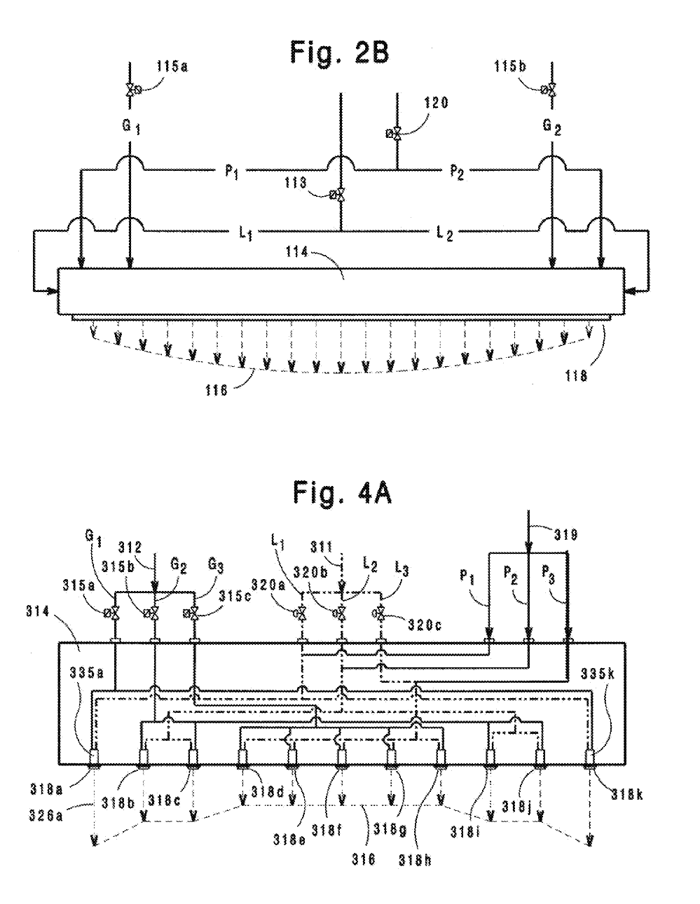

FIG. 2B is a front view of a second embodiment of the cryogenic cooling device of the present invention;

FIGS. 4A and 4B are front views of third and forth embodiments of the cryogenic cooling device of the present invention, each having “sectionalized” or “zoned” nozzle configurations; and

FIG. 5 is a front view of a fifth embodiment of the cryogenic cooling device of the present invention.

### DETAILED DESCRIPTION OF THE INVENTION

The ensuing detailed description provides preferred exemplary embodiments only, and is not intended to limit the scope, applicability, or configuration of the invention. Rather, the ensuing detailed description of the preferred exemplary embodiments will provide those skilled in the art with an enabling description for implementing the preferred exemplary embodiments of the invention. It being understood that various changes may be made in the function and arrangement of elements without departing from the spirit and scope of the invention, as set forth in the appended claims.

To aid in describing the invention, directional terms may be used in the specification and claims to describe portions of the present invention (e.g., upper, lower, left, right, etc.). These directional terms are merely intended to assist in describing and claiming the invention and are not intended to limit the invention in any way. In addition, reference numerals that are introduced in the specification in association with a drawing figure may be repeated in one or more subsequent figures without additional description in the specification in order to provide context for other features.

In the specification, elements which are common to more than one disclosed embodiment of the invention are identified in the drawings using reference numerals that differ by factors of 100. For example, a first embodiment of a cryogenic cooling device is identified in the specification and in FIG. 2A by reference numeral 14 and a second embodiment of the cryogenic cooling device is identified in the specification and in FIG. 2B by reference numeral 114. Elements which are discussed in the specification with respect to one embodiment may be identified by reference numeral in other embodiments in which that element appears, but may not be independently referred to in the specification.

As used herein, the term “cryogenic fluid” is intended to mean a liquid, gas or mixed-phase fluid having a temperature less than −70 degrees C. (203 degrees K). Examples of cryogenic fluids include liquid nitrogen (LIN), liquid oxygen (LOX), and liquid argon (LAR), liquid carbon dioxide and pressurized, mixed phase cryogens (e.g., a mixture of LIN and gaseous nitrogen).

As used herein, the term “cryogenic cooling device” is intended to mean any type of apparatus or device which is designed to discharge or spray a cryogenic fluid (either in liquid, mixed-phase, or gaseous form). Examples of cryogenic cooling devices include, but are not limited to, cryogenic spray bars, individual cryogenic spray nozzles, and devices containing arrays of cryogenic spray nozzles.

Referring to FIG. 1, a first embodiment of the invention is shown. A cryogenic cooling device 14 is installed in a cold roll mill stand 1, which forms part of a cold rolling process. The mill stand 1 includes a pair of opposed work rolls 2 and 3, adjusted to a selected roll gap 4 for receiving and deforming incoming metallic sheet (or strip) 5 that moves in a direction 8 to a predetermined thickness. The strip 5 is plastically deformed between the work rolls 2 and 3 to a desired thickness.

In this embodiment, the cryogenic cooling device 14 is positioned above the strip 5 and is discharging cryogenic coolant onto the surface of the strip 5. In other embodiments, the cryogenic cooling device 14 could be positioned and directed to discharge coolant onto other surfaces, such as the bottom surface of the strip 5, onto the surface of one of the rolls 2, 3 or into the roll “bite” (where the strip 5 meets the rolls 2, 3). In addition, multiple cryogenic cooling devices 14 could be provided. The position, direction of discharge and number of cryogenic cooling devices 14 will depend upon the operating parameters of the cold rolling process in which they are used.

In this embodiment, the cryogenic cooling device 14 is a spray bar having a plurality of nozzles 18 from which coolant is discharged. In this embodiment, the nozzles 18 are arranged in a (linear) row. The coolant discharge from the plurality of nozzles 18 as a group defines a cryogenic cooling profile 16 (shown schematically in FIG. 1).

Referring to FIG. 2A, the cryogenic cooling device 14 is capable of producing non-uniform cryogenic cooling profiles. An exemplary non-uniform cryogenic cooling profile 16 is shown in FIG. 2A. The length of the arrow-headed dashed lines 26a through 26k represent the cooling intensity discharged from each of the respective nozzles 18a through 18k, with a longer line indicating greater cooling intensity and the arrow head indicating the direction of flow. In order to simplify this figure, only the left-most and right-most nozzles 18a and 18k and dashed lines 26a through 26k are labeled. Similar labeling simplification is repeated for other features of the invention having multiple duplicate features. In FIG. 2A, the cryogenic cooling profile 16 has maximum cooling intensity at the center of the cryogenic cooling device 14. The cooling intensity decreases to a minimum at each end of the cryogenic cooling device 14.

Cryogenic cooling devices 14 and 114 (FIG. 2B) are very similar to the tube-in-tube cryogenic spray bar disclosed in U.S. patent application Ser. No. 11/846,116, filed Aug. 28, 2007, which is incorporated herein by reference as if fully set forth. A cryogenic fluid is supplied to the cryogenic cooling device 14 by two cryogenic fluid supply lines L1 and L2. A throttling gas is supplied to the cryogenic cooling device by two throttling gas supply lines G1 and G2. An optional purge gas is supplied to the cryogenic cooling device by two purge gas supply lines P1 and P2.

In this embodiment, the supplied cryogenic fluid flows into an inner tube and then into a “contact zone” located between the inner tube and the outer tube, where it mixes with the throttling gas. The tube-in-tube structure is fully disclosed in U.S. patent application Ser. No. 11/846,116, and therefore is neither shown in FIG. 2A nor discussed in detail herein. As explained in detail in U.S. patent application Ser. No. 11/846,116, adjusting the pressure at which the throttling gas is supplied to the cryogenic cooling device 14 via each of the throttling gas supply lines G1 and G2 enables the cryogenic cooling profile to be adjusted and controlled and enables the generation of non-uniform cryogenic cooling profiles.

A proportional valve 15a, 15b (i.e., adjustable over a range of positions between fully open and fully closed) is provided on each of the throttling gas supply lines G1 and G2, which enable the pressure at which the throttling gas is supplied to the cryogenic cooling device 14 to be regulated in each of the throttling gas supply lines G1 and G2. In this embodiment, a single valve 13 is provided to control the flow of cryogenic fluid through the cryogenic fluid supply lines L1 and L2. A single valve 13 is used in this embodiment because it is unnecessary (and difficult) to independently adjust the respective flow rates in each of the cryogenic fluid supply lines L1 and L2. In other embodiments, a valve could be provided on each of the cryogenic fluid supply lines L1 and L2.

Proportional valves (including valves 15a, 15b) are described in this application as being used to regulate the pressure at which throttling gas is supplied to a cryogenic cooling device (including device 14). It should be understood that, the proportional valves of the embodiments of the invention described herein, are adjusted by increasing or decreasing the size of the opening through which the throttling gas flows, which causes a corresponding increase or decrease, respectively, in the flow rate of throttling gas through the opening. Increasing the size of the opening also decreases the pressure drop across the proportional valve, and therefore, increases the pressure of the throttling gas downstream of the proportional valve. Conversely, decreasing the size of the opening increases the pressure drop across the proportional valve, and therefore, decreases the downstream pressure of the throttling gas. Therefore, in the embodiments of the invention described herein, adjusting a proportional valve regulates both the flow rate and the pressure at which the throttling gas is provided to the cryogenic cooling device.

Because the extremely low temperatures associated with cryogens can cause icing conditions that adversely affect control valve adjustment, valve 13 is normally opened at the start of rolling operations to provide a desired flow rate of cryogenic fluid and is not adjusted until rolling is terminated. It should be understood, however, that adjusting the valve 13 during rolling operations is not considered outside the scope of the present invention.

The purge gas supply lines P1 and P2 provide a means for preventing the build-up of condensation and frost on the cryogenic cooling device 14, as set forth in PCT International Application No. PCT/US08/74462 on Aug. 27, 2008, filed concurrently with this application, which is incorporated herein by reference as if fully set forth. A single valve 20 is provided to control the flow of purge gas through the purge gas supply lines P1 and P2. In the interest of brevity, other structural elements disclosed in the above-referenced PCT Application which support the condensation and frost prevention feature are not repeated herein.

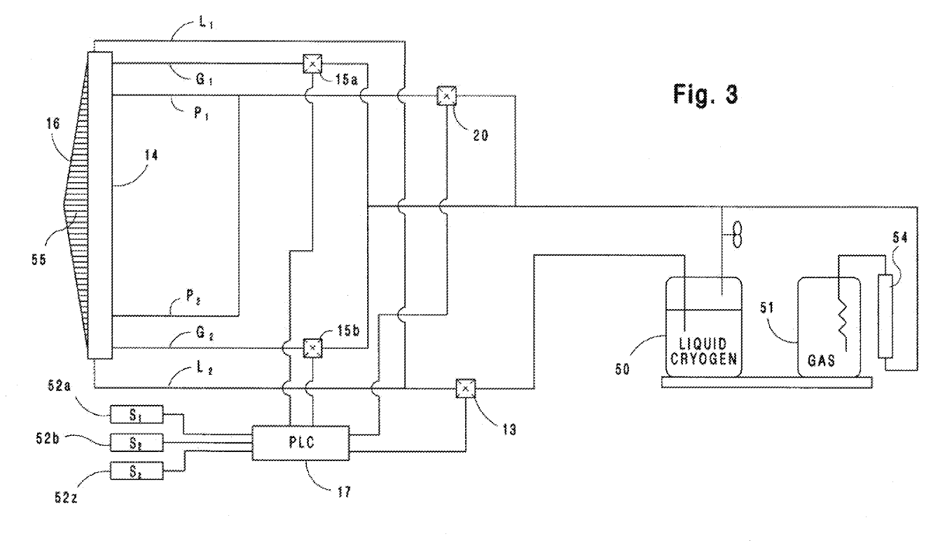

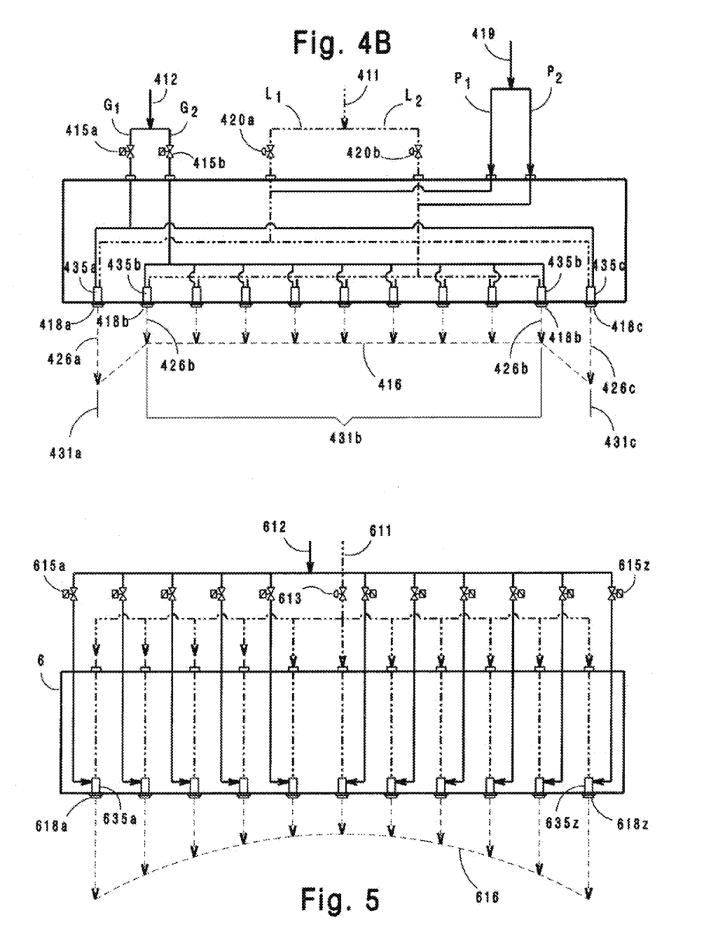

FIG. 3 shows a delivery and control system embodiment for use with the cryogenic cooling device 14. The cryogenic fluid is supplied to the cryogenic fluid supply lines L1 and L2 by a tank 50, which may optionally include a pressure regulator 53. Similarly, the throttling gas is supplied to the throttling gas supply lines G1 and G2 by a tank 51, which may optionally include a vaporizer 54. The tank 51 also supplies the purge gas to the purge gas supply lines P1 and P2. Alternatively, the cryogenic fluid, throttling gas and purge gas could be supplied by a single tank, which would preferably have a vaporizer and a phase separator.

In this embodiment, the cryogenic fluid is liquid nitrogen (LIN) and the throttling and purge gases are gaseous nitrogen (at ambient temperature). The LIN may be supplied to the cryogenic cooling device as a liquid or in mixed-phase. Obviously other cryogenic fluids, throttling gases and purge gases could be used. In order to avoid condensation of the throttling gas when it meets the cryogenic fluid, it is preferable that the boiling point of the throttling gas be no greater than the boiling point of the cryogenic fluid.

A controller 17 receives data from a group of sensors 52a through 52c, each of which measure a parameter of the cold rolling process. The sensors 52a through 52c each preferably measure a parameter of the cold rolling process which will affect the desired cryogenic cooling profile 16 of the cryogenic cooling device 14. In accordance with the present invention, the desired cryogenic cooling profile 16 is preferably a profile that improves uniformity of the strip 5 and/or minimizes damage to the strip 5 during the cold rolling process. The desired cryogenic cooling profile 16 will depend upon many factors, including, but not limited to, the parameters measured by one or more of the sensors 52a through 52c.

There are many operating parameters of the cold rolling process which could affect the desired cryogenic cooling profile 16. Many of these operating parameters relate to physical properties of the strip 5. Examples include, but are not limited to:
1. the overall temperature of the strip 5;
2. the overall temperature of the rolls 2, 3;
3. the temperature profile across the width of the strip 5 (i.e., the direction perpendicular to the direction 8 shown in FIG. 1);
4. the temperature profile across the width of the rolls 2, 3 (i.e., the direction perpendicular to the direction 8 shown in FIG. 1);
5. the shape (thickness, crown, etc.) of the strip 5;
6. stress on the strip 5;
7. stress in the rolls 2, 3;
8. the velocity of the strip 5 or the rolls 2, 3;
9. the width of the strip 5; and
10. the diameter of the rolls, 2, 3 at several points along the rotational axis of the rolls 2, 3.

In this embodiment, sensor 52a measures the velocity of the strip 5, sensor 52b measures the temperature profile across the width of the strip 5 and sensor 52c measures the width of the strip 5. Different numbers of sensors could be provided in other embodiments and different combinations of parameters could be measured.

The controller 17 is preferably programmed to determine a desired cryogenic cooling profile 16 based on data received from the sensors 52a through 52c. For example, the controller 17 could be programmed to increase the overall intensity of the desired cryogenic cooling profile 16 (by further opening both valves 15a and 15b) if the sensor 52a detects an increase in the velocity of the strip 5. As another example, the controller 17 could be programmed to generate a cryogenic cooling profile 16 having a localized increase in intensity at the portion of the strip 5 in which a higher temperature is measured by the sensor 52b (e.g., in the center of the strip 5).

Once a desired cryogenic cooling profile 16 has been determined, the controller 17 makes any necessary adjustments to the valves 15a and 15b to generate the desired cryogenic cooling profile 16. As measurements from the sensors 52a through 52c change (i.e., to reflect a change in a measured parameter of the cold rolling process), the desired cryogenic cooling profile 16 may change, in which case the controller 17 will make further adjustments to the valves 15a and 15b to regulate the throttling gas pressure in the throttling gas supply lines G1 and G2 to generate the current desired cryogenic cooling profile 16. Accordingly, the present invention provides that capability to quickly and automatically adjust the cryogenic cooling profile 16 to changing process conditions.

As discussed above in the Background section, at many stages of cold rolling processes, the physical characteristics of the strip (e.g., temperature, thickness, etc.) are not uniform across the width of the strip. Therefore, the capability of the present invention to produce non-uniform cryogenic cooling profiles, particularly when taken in combination with ability of the present invention to quickly adjust to changing process conditions, can be advantageously used on cold rolling processes to produce an improved shape in a rolled product.

In this embodiment, the controller 17 is also adapted to adjust the valve 13 for the cryogenic fluid supply lines L1 and L2, as well as the valve 20 for the purge gas supply lines P1 and P2. Controller 17 may adjust valve 13 to increase the flow of purge gas if there is an overall increase in the intensity of the cryogenic cooling profile 16. In this embodiment and as explained above, the valve 20 is preferably not adjusted during operation of the cold rolling process.

It should be noted that the delivery and control system shown in FIG. 3, including the controller 17 and sensors 52a, 52b, and 52c could be used with any of the embodiments of the cryogen cooling device disclosed in this application.

FIG. 2B shows a second embodiment of the cryogenic cooling device 114. The cryogenic cooling device 114 is very similar to the cryogenic cooling device 14 shown in FIG. 2A, the primary difference being that the discharge comprises an elongated slot 118 instead of a plurality of nozzles 18a through 18k. In addition, the cryogenic cooling profile 116 shown in this embodiment is slightly different.

FIG. 4A shows a third embodiment of the cryogenic cooling device 314, which provides for “sectionalized” or “zoned” control of a plurality of discharge nozzles 318a through 318k. Each of the nozzles 318a through 318k includes an internal manifold 335a through 335k, respectively, which is where the throttling gas and cryogenic fluid meet and mix (performing the same function of the mixing zone in the cryogenic cooling devices 14 and 114). The plurality of discharge nozzles 318a through 318k are grouped into three zones. The first zone comprises the nozzles 318d through 318h, which are the nozzles in the center of the cryogenic cooling device 314. The second zone consists of the nozzles 318b, 318c, 318i and 318j, which are outboard of (i.e., on either side of or flank) the nozzles of the first zone. The third zone consists of nozzles 318a and 318k, which are outboard of the nozzles of the first and second zones.

The cryogenic fluid, throttling gas and purge gas are supplied to the nozzles of each of the zones using one supply line per zone. For example, nozzles 318a and 318k of the third zone are supplied with cryogenic fluid by a cryogenic supply line L1, with throttling gas by throttling gas supply line G1, and with purge gas by purge gas supply line P1. In this embodiment, an adjustable valve 315a, 315b, 315c is provided on each of the throttling gas supply lines G1, G2 and G3. A valve 320a, 320b, 320c is also provided on each of the cryogenic fluid supply lines.

In order to simplify the connection to a supply tank a backend throttling gas supply line 312 is provided, which splits into the throttling gas supply lines G1, G2 and G3 upstream from the valves 315a, 315b, 315c. Similarly, backend supply lines 311 and 319 are also provided for the cryogenic supply lines L1, L2 and L3 and the purge supply lines P1, P2 and P3, respectively.

Having multiple nozzles grouped in “zones,” with each zone having an independently-adjustable throttling gas supply, provides additional flexibility in the operation of the cryogenic cooling device 314. A larger cooling intensity difference between zones is possible in this embodiment than in the cryogenic cooling devices 14 and 114 shown in FIGS. 2A and 2B. In addition, in this embodiment, it is possible to have greater cooling intensity near the ends of the cryogenic cooling device 314 (i.e., the third zone) than in the center (i.e., the first zone). Finally, “zoned” or “sectionalized” nozzles also enables the nozzles in any one of the zones to be turned off by increasing the throttling gas pressure delivered to nozzles in that zone until little or no cryogenic fluid is being discharged, or by closing the valve on the associated cryogenic supply line. This enables the cryogenic cooling device 314 to operate more efficiently when a relatively narrow strip is being rolled in the cold rolling process, which could result in significant operating cost savings. For example, if the width of the strip being rolled was only as wide as the first zone (spanning from nozzles 318d through 318h), the nozzles of the second and third zones could be turned off. As noted above, sensor 52c is configured to detect the width of the strip 5. Therefore, the controller 17 could be programmed to automatically turn zones on and off depending upon the detected width of the strip 5. The sectionalized cooling capability of the cryogenic cooling device 314 would also enable quick operational transitions between strips of different widths.

FIG. 4B shows a fourth embodiment of the cryogenic cooling device 414, which is very similar to the third embodiment of the cryogenic cooling device 314, but includes two zones instead of three zones.

FIG. 5 shows a fifth embodiment of the cryogenic cooling device 614, which includes a throttling gas supply line having an adjustable valve and a cryogenic fluid supply line for each of a plurality of nozzles. In order to simplify FIG. 5, only the leftmost throttling gas valve 615a and the rightmost throttling gas valve 615k are labeled. Similarly, only the leftmost and rightmost nozzles 618a, 618k are labeled, along with the leftmost and rightmost manifolds 635a, 635k associated with each nozzle. In addition, the throttling gas supply lines are shown as solid lines and the cryogenic fluid supply lines are shown using lines having a dash, double-dot pattern. A single valve 613 controls the flow of cryogenic fluid through all of the cryogenic fluid supply lines.

Due to the fact that each nozzle has its own throttling gas supply line and adjustable valve, the cryogenic cooling device 614 provides the greatest degree of flexibility in generating cryogenic cooling profiles. This flexibility comes at the cost, however, of increased weight, complexity and manufacturing cost. Therefore, use of the cryogenic cooling device 614 is likely to only be warranted in applications having desired cryogenic cooling profiles that cannot be generated using the any of the first through fourth embodiments of the cryogenic cooling device discussed above.

As such, an invention has been disclosed in terms of preferred embodiments and alternate embodiments thereof, which fulfills each one of the objects of the present invention as set forth above and provides a method and apparatus for a non-linear cryogenic liquid spray profile across the width of a metallic product rolled in a cold roll mill stand. Of course, various changes, modifications, and alterations from the teachings of the present invention may be contemplated by those skilled in the art without departing from the intended spirit and scope thereof. It is intended that the present invention only be limited by the terms of the appended claims.

1. A method comprising:
determining a non-uniform cryogenic cooling profile for a discharge of a cryogenic cooling device that is part of an industrial process based on at least one operating parameter of the industrial process; and
generating the non-uniform cryogenic cooling profile.

2. The method of claim 1, wherein the determining step comprises determining the non-uniform cryogenic cooling profile for the discharge of the cryogenic cooling device based on the at least one operating parameter of the industrial process for the purpose of improving uniformity of a product of the industrial process.

3. The method of claim 1, wherein the generating step comprises generating the non-uniform cooling profile by supplying a cryogenic fluid to the cryogenic cooling device and regulating the pressure of each of at least one throttling gas supply line to the cryogenic cooling device.

4. The method of claim 3, wherein the generating step comprises generating the non-uniform cooling profile by supplying a cryogenic fluid to the cryogenic cooling device and regulating the pressure of each of at least one throttling gas supply line to the cryogenic cooling device using a controller that is adapted to control an adjustable valve on each of the at least one throttling gas supply line.

5. The method recited in claim 1, wherein the generating step comprises generating the non-uniform cooling profile by supplying liquid or mixed-phase nitrogen to the cryogenic cooling device and regulating the pressure of at least one gaseous nitrogen supply line to the cryogenic cooling device.

6. The method recited in claim 1, wherein the generating step comprises:
supplying a cryogenic fluid and a throttling gas to each of a plurality of nozzles for the cryogenic cooling device; and
regulating a pressure of the throttling gas in a manner that generates the non-uniform cryogenic cooling profile.

7. The method recited in claim 1, wherein the generating step comprises supplying a throttling gas to each of two throttling gas supply lines located on the cryogenic cooling device at a pressure that generates the non-uniform cryogenic cooling profile, the discharge of the cryogenic cooling device comprising an elongated slot.

8. The method of claim 1, wherein the generating step comprises:
supplying a throttling gas to each of first and second throttling gas supply lines, the first throttling gas supply line being in flow communication with a first group of nozzles and the second throttling gas supply line being in flow communication with a second group of nozzles, the second group of nozzles being located outboard of the first group of nozzles; and
regulating a pressure of the throttling gas supplied to each of the first and second throttling gas supply lines.

9. The method of claim 1, further comprising:
adjusting the non-uniform cooling profile in response to a change in the at least one operating parameter of the industrial process; and
generating the adjusted non-uniform cooling profile.

10. The method of claim 9, wherein generating the adjusted non-uniform cooling profile comprises adjusting at least one throttling gas supply line to the cryogenic cooling device without adjusting any of at least one cryogenic fluid supply line to the cryogenic cooling device.

11. The method recited in claim 1, wherein the determining step comprises determining the non-uniform cryogenic cooling profile for the discharge of the cryogenic cooling device based on at least one operating parameter of a cold rolling process.

12. The method recited in claim 11, wherein the determining step comprises determining the non-uniform cryogenic cooling profile for the discharge of the cryogenic cooling device based on at least one operating parameter of a cold rolling process, the at least one operating parameter including one or more selected from the group of temperature measurements from a strip being rolled by the cold rolling process, temperature measurements from a roll that is part of the cold rolling process, shape measurements from the strip, stress measurements from the strip, and stress measurements from the roll.

13. The method of claim 1, further comprising positioning the discharge of the cryogenic cooling device at an element of the industrial process.

14. The method of claim 13, wherein the positioning step comprises positioning the discharge of the cryogenic cooling device at an element of the industrial process, the element being selected from the group of a roll that is part of the industrial process and a strip being rolled by the industrial process.

15. An apparatus for use in an industrial process, the apparatus comprising:
a cryogenic cooling device having at least one discharge opening, the cryogenic cooling device being connected to at least one cryogenic fluid supply line and at least one discharge opening, the cryogenic cooling device being configured so that flow of cryogenic fluid through each of the at least one discharge opening is a function of the pressure at which a throttling gas is supplied to each of the at least one throttling gas supply line;
at least one valve that regulates flow of the throttling gas through each of the at least one throttling gas supply line; and
a controller having at least one sensor adapted to measure at least one operating parameter of the industrial process;
wherein the controller is programmed to adjust each of the at least one valve to generate a desired cryogenic cooling profile for the cryogenic cooling device based on input from the at least one sensor.

16. The apparatus of claim 15, wherein the at least one discharge opening comprises a plurality of nozzles.

17. The apparatus of claim 15, wherein the at least one throttling gas supply line comprises first and second throttling gas supply lines and the at least one discharge opening comprises first and second groups of nozzles, the second group of nozzles being located outboard of the first group of nozzles, the first throttling gas supply line being in flow communication with a first group of nozzles and the second throttling gas supply line being in flow communication with a second group of nozzles.

18. The apparatus of claim 15, wherein the at least one valve comprises a first valve located on the first throttling gas supply line and a second valve located on the second throttling gas supply line.

19. The apparatus of claim 17, wherein the first and second groups of nozzles are arranged in a row.

20. The apparatus of claim 15, wherein the controller is capable of generating a non-uniform cooling profile for the cryogenic cooling device.

21. The apparatus of claim 15, wherein the at least one operating parameter of the industrial process comprises one or more physical properties of a strip being rolled by the industrial process and a roll that is part of the industrial process.

22. The apparatus of claim 21, wherein the at least one operating parameter of the industrial process comprises one or more selected from the group of temperature measurements from the strip, temperature measurements from the roll, shape measurements from the strip, stress measurements from the strip, and stress measurements from the roll.
